(19) United States
(12) Patent Application Publication
(10) Pub. No.: US 2020/0228260 A1
(43) Pub. Date: Jul. 16, 2020

(54) BUFFER HANDLING UTILIZING IN-BAND CONTROL SIGNALING

(71) Applicant: TELEFONAKTIEBOLAGET LM ERICSSON (PUBL), Stockholm (SE)

(72) Inventors: Anders JONSSON, Täby (SE); Stefan ENG, Linköping (SE); Torbjörn ÖRTENGREN, Linköping (SE)

(21) Appl. No.: 16/626,866

(22) PCT Filed: Jun. 25, 2018
(86) PCT No.: PCT/IB2018/054675

§ 371 Date: Dec. 26, 2019

Related U.S. Application Data
(60) Provisional application No. 62/525,032, filed on Jun. 26, 2017.

(51) Int. Cl. H04L 1/18; H04W 76/12

(52) U.S. Cl. CPC H04L 1/1874; H04L 2001/0097; H04W 76/12; H04L 1/1896

(57) ABSTRACT

Disclosed herein is a method, network node, and computer program product for buffer handling utilizing in-band control signaling. The method includes storing, in a buffer memory, first data to be transmitted to a user equipment. The method further includes obtaining a discard message from a second network node. The method additionally includes discarding the first data based on the discard message. In another embodiment, the method includes obtaining a transmission status feedback message. The method also includes determining that a first buffer memory of a second network node contains first data. The method further includes sending a discard message to the second network node. The discard message comprises an indication that the second network node is to discard the first data.

### TECHNICAL FIELD

Particular embodiments relate to the field of buffer handling technology; and more specifically, to methods, apparatus and systems for utilizing in-band control signaling in the 5G generation radio to discard redundant data.

### BACKGROUND

Current state of the art buffer handling technology usually utilizes an age-based or volume-based method of controlling buffered data, sometimes referred to as Active Queue Management (AQM). While AQM was originally conceived to work in single connectivity (SC) scenarios it is also beneficial in Dual- or Multi-Connectivity scenarios (henceforth referred to collectively as MC). However, the AQM functionality needs to be complemented in a MC scenario where the same data has been sent in both DC legs.

AQM usually uses an age-based or volume-based method of controlling buffered data meaning that data is kept in the buffer until the buffer reaches a certain level in terms of data volume or if the data in the buffer reaches a certain age after which it is discarded. The problem in DC is that legacy AQM control only uses packet age or packet volume to control the buffer and does not provide a method to discard data in a scenario in which the same data has been sent to two separate 5G radio network nodes (henceforth referred to as Distributed Units or DU's) but only successfully transmitted over one DU to the user equipment (UE). This makes the data residing in the other DU redundant.

As an example, if data is being sent over both legs in a DC scenario and the data transmission is in balance, the UE will receive the data more or less in order from both DU's. However, the data transmissions from the two DU's to the UE can never be completely synchronized and therefore the UE is equipped with a reordering buffer on the packet data convergence protocol (PDCP) level so that data can arrive slightly out of sequence from both legs but still be delivered to higher layers in sequence. This functionality in the UE ensures that as long as the data transmissions from both legs are reasonably well synchronized and the buffers in both DU's balanced there is no need for any active buffer control.

In order to fully utilize the available bandwidth which may vary significantly from one transmission opportunity to the next, both DU's need a certain buffer margin to ensure that there is always enough data available for each transmission. However, the radio transmission conditions for the two legs may be significantly different, and in some cases the two legs may also be operating at different frequencies, sometimes as large as an order of magnitude apart, e.g. for example at roughly 3 and 30 GHz. This means that while the radio conditions and coverage conditions on one leg may remain stable, the radio conditions on the other leg could suddenly deteriorate significantly or even temporarily cease altogether.

Consequently, since there is already data residing in each DU buffer and that data may be in flight together with the fact that there is a certain reaction time before the flow control in the CU adjusts the flow of data to a change in the throughput, if one leg loses coverage there will be a significant amount of data residing in a DU that cannot be transmitted to the UE. Since the UE has a limited re-ordering buffer, this data needs to be retransmitted over the other leg as soon as possible. If this retransmitted data is then successfully transmitted by the DU with the best radio conditions, this makes the data in the other DU redundant. Consequently, in a DC scenario data may need to be sent on both legs in some cases making the data residing in one leg redundant and, in order not to waste available bandwidth, in need of being discarded.

### SUMMARY

To address the foregoing problems with existing solutions, disclosed is methods and network nodes for buffer handling utilizing in-band control signaling.

The solutions disclosed herein include a method to expediently clear redundant data from a buffer utilizing in-band control signaling. This method will be especially beneficial in 5G dual connectivity scenarios involving higher frequencies with limited coverage. While several methods of conveying the discard information is possible, one possible method utilizes the Next Extension Header field in a GPRS Tunneling Protocol User plane (GTP-U) packet data unit (PDU). This discard signal may be sent either on both legs (in which case the DU which has already transmitted the data is configured to ignore the message) or in another embodiment only to the node where the redundant data is residing. The trigger for sending the discard indication to the DU or DU's is that the same data has been sent on both legs and the reception in the CU of an acknowledgement (ACK) of the same data from the DU's, one of the DU's or the UE, wherein the DU receives an acknowledgement from the UE. The acknowledgement may be a PDCP ACK.

The discard indication may also be sent as a means of buffer control: Even if data is not duplicated, the amount of data residing in a queue measured in terms of the time it takes to transmit given the current transmission rate may be seconds due to changing radio conditions

Some embodiments may benefit from a cloud implementation where the network nodes are physically separated from each other. For example, in a virtualized environment the DU's serving a UE may be separated both physically and in the frequency domain meaning the transmission characteristics for each separate DU may vary significantly over time and it is therefore especially important that redundant data can be discarded as expediently as possible.

There are, proposed herein, various embodiments which address one or more of the issues disclosed herein. One such embodiment includes a method for use in a network node for buffer handling utilizing in-band control signaling. The method comprises storing first data in a buffer memory. The first data is to be transmitted to a UE. The method additionally comprises obtaining a discard message from a second network node and discarding the first data based on the discard message. Another embodiment includes a method performed by a base station for buffer handling utilizing in-band control signaling. The method includes storing a first data in a buffer. The data is to be transmitted to a first UE. The method additionally includes, prior to receiving an acknowledgement message from the first UE indicating that the first UE received the first data, obtaining a discard message. The method further includes discarding the first data from the buffer based on the discard message.

In some embodiments, the discard message comprises a GTP-U PDU. In particular embodiments, the GTP-U PDU comprises an indication in a Next Extension Header of the GTP-U PDU.

In some embodiments, the buffer comprises a plurality of data, each data of the plurality of data having a number associated therewith. Additionally, the discard message comprises an indication that all data in the buffer up to specified number is to be discarded. In some embodiments, the discard message comprises an indication that specific numbers of data are to be discarded.

Another embodiment includes a method performed by a network node for buffer handling utilizing in-band control signaling. The method comprises obtaining a transmission status feedback message. The method additionally comprises determining that a first buffer memory of a second network node contains first data. The method also comprises sending a discard message to the second network node, the discard message comprises an indication that the second network node is to discard the first data. Yet another embodiment includes a method performed by a network node for buffer handling utilizing in-band control signaling includes obtaining a first transmission status feedback message. The method additionally includes determining a first base station's buffer contains redundant data based on the first transmission status feedback message. The method also includes sending a discard message to the first base station, the discard message comprises an indication that the first base station is to discard the redundant data.

In some embodiments, the first transmission status feedback message is obtained from a second base station. The first transmission status feedback message comprises an indication that the second base station delivered the redundant data to a UE. In some embodiments, the first base station uses a first radio access technology (e.g., LTE) and the second base station uses a second access technology (e.g., NR) different than the first access technology. In some embodiments, the first base station and the second base station are alternating in sending data to the UE.

In certain embodiments, the first transmission status feedback message is obtained from the first base station. The first transmission status feedback message comprises an indication that a wireless connection between the first base station and a UE has deteriorated.

Certain embodiments may provide one or more of the following technical advantage(s). Redundant data can be discarded before it is transmitted over the air interface thus saving valuable bandwidth. Another advantage is that a DU that has a temporal loss of coverage can clear its buffer of redundant data and be ready to transmit new data as soon as coverage is restored.

Various other features and advantages will become obvious to one of ordinary skill in the art in light of the following detailed description and drawings. Certain embodiments may have none, some, or all of the recited advantages.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of centralized unit and distributed units in the multi-connectivity scenario, according to certain embodiments;

FIG. 2 illustrates an example of data fields, according to certain embodiments;

FIG. 3 illustrates another example of data fields, according to certain embodiments;

FIG. 4 illustrates an example wireless network, according to certain embodiments;

FIG. 5 illustrates an example user equipment, according to certain embodiments;

FIG. 6 illustrates an example virtualization environment, according to certain embodiments;

FIG. 7 illustrates an example telecommunication network connected via an intermediate network to a host computer, according to certain embodiments;

FIG. 8 illustrates an example host computer communicating via a base station with a user equipment over a partially wireless connection, according to certain embodiments;

FIG. 9 illustrates an example method implemented in a communication system including a host computer, a base station and a user equipment, according to certain embodiments;

FIG. 10 illustrates another example method implemented in a communication system including a host computer, a base station and a user equipment, according to certain embodiments;

FIG. 11 illustrates another further example method implemented in a communication system including a host computer, a base station and a user equipment, according to certain embodiments;

FIG. 12 illustrates another example method implemented in a communication system including a host computer, a base station and a user equipment, according to certain embodiments;

FIG. 13 illustrates a flow diagram of a method in a network node, in accordance with certain embodiments;

FIG. 14 illustrates a flow diagram of another method in a network node, in accordance with certain embodiments;

FIG. 15 illustrates a block schematic of an exemplary base station, in accordance with certain embodiments; and

FIG. 16 illustrates a block schematic of an exemplary network node, in accordance with certain embodiments.

### DESCRIPTION OF EMBODIMENTS

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Disclosed herein are embodiment that relate to buffer handling in the new 5G generation radio. There are proposed herein ways to improve the buffer handling by utilizing in-band control signaling to discard redundant data.

The control of the flow of data and to which DU each unit of data is to be sent may reside in a 5G packet processing function, henceforth referred to as the Centralized Unit or CU, which is logically either placed as a separate node between the DU's and the new generation core network (NGC), or residing in one on the DU's but controlling the split of data traffic between both DU's thus creating a controlling and secondary DU. The CU MAY reside in one of the DU's as an integrated node, a component, or a unit. In some embodiments, the CU may be a separate node from the DU. The CU function includes flow control functionality which ensures that the data sent from higher layers in a DC scenario is appropriately split between the two legs based on the data handling capacity of each leg. Note that the CU may be one unit or may be both logically and physically split into two separate functions that handle user plane and control data separately.

Note that the terms DU and CU may be used herein to be consistent with the designations given these network nodes in 3GPP standardization. In some embodiments, the CU is split into a vPP and a vRC and the term BPF may be used for the DU.

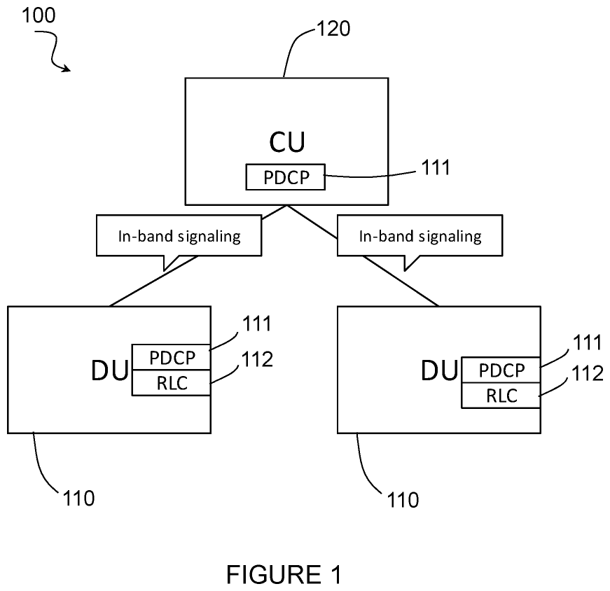

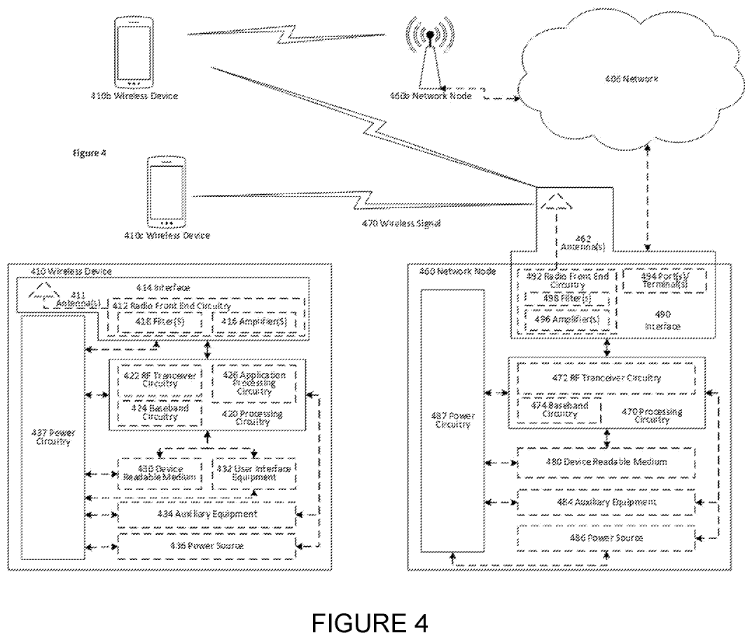

FIG. 1 is an example of centralized unit 120 and distributed units 110 in the multi-connectivity scenario 100, in accordance with certain embodiments. Typical use cases for the DU 110 buffer control disclosed herein are for MC or when switching data transmission between legs in a MC scenario 100. In a MC scenario 100 involving at least two legs 110, for example leg 1 over LTE and leg 2 over NR, flow control maintains a PDCP 111 data buffer for each leg 110 that radio link control (RLC)/medium access control (MAC) 112 can draw data from. In this MC scenario 100, the leg 110 is a distributed unit. In order to achieve the highest possible aggregated rate that fully utilizes the available bandwidth in each leg 110, flow control needs to maintain a slight margin in terms of buffer size, i.e. at any given time there needs to be a slight excess of PDCP 111 data in both legs 110 to avoid the possibility that there is not enough data available to fully utilize the momentanes L1 bandwidth capacity. A further detailed description of a node that may include functionality of distributed unit 110 is illustrated in FIG. 4.

This means that if the radio conditions in one leg 110 deteriorates, the packet age will increase rapidly partly due to the packets already residing in the buffer awaiting transmission but also due to the PDCP 111 packets that will be transmitted by flow control before flow control becomes aware of the changed radio conditions and can adjust the flow rate. In addition, if one leg 110 loses coverage completely, the data may need to be transmitted on the other leg 110 which will make the data in the leg 110 with coverage problems redundant as soon as the data has been successfully transmitted on the other leg 110.

In addition, in a MC scenario 100 where data transmission is switched alternatingly between two legs 110, it is beneficial if the data left in leg 1 from which transmissions have been suspended is discarded since it will be transmitted over the other leg 110 (leg 2). This will ensure that the redundant data (redundant since it has been transmitted over leg 2) residing in leg 1 will be discarded and leg 1 will be ready to transmit.

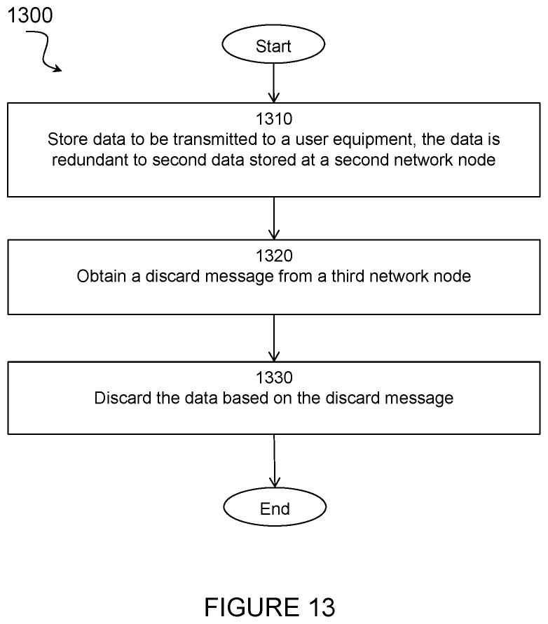

Consequently, there is a need to remove the redundant data from the PDCP 111 queue in the leg 110 with coverage problems. In addition, it would be beneficial to remove PDCP 111 data that is no longer residing in the PDCP 111 queue, but which has already been conveyed to RLC 112 and is in the process of being transmitted. A further detailed description of functionality associated with discarding data is illustrated in FIG. 13.

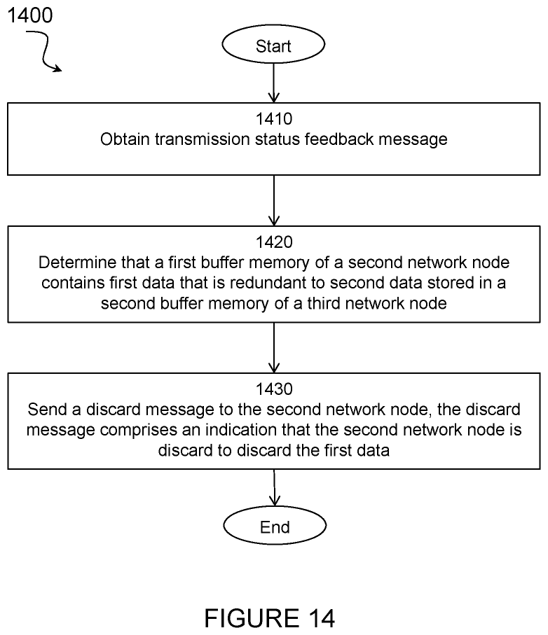

In some embodiments, the decision to discard data is based on transmission status feedback from the DU's 110. For the purpose of flow control, both DU's 110 provide feedback information concerning which PDCP 111 PDU's have been delivered in each leg 111. This information is used by the buffer discard control function in the CU 120 to determine on which leg 110 to send the in-band discard message. As an example, data sent to leg 2 may be delayed and a decision is taken in the CU 120 to transmit the same data on leg 1. Consequently, the same data is now residing in both legs 110 and depending on transmission conditions one leg 110 will provided feedback information that the data has been successfully transmitted. This triggers the transmission of an in-band GTP-U discard indication. In some embodiments, the in-band GTP-U discard indication is a discard message. In certain embodiments, functionality of CU 120 may reside in DU 110. In some embodiments, DU 110 may comprise a processor to perform the functions of the CU 120. A further description of the CU 120 sending a discard indication is illustrated in FIG. 14.

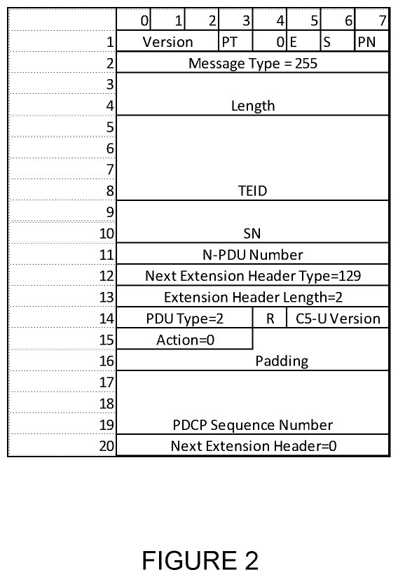

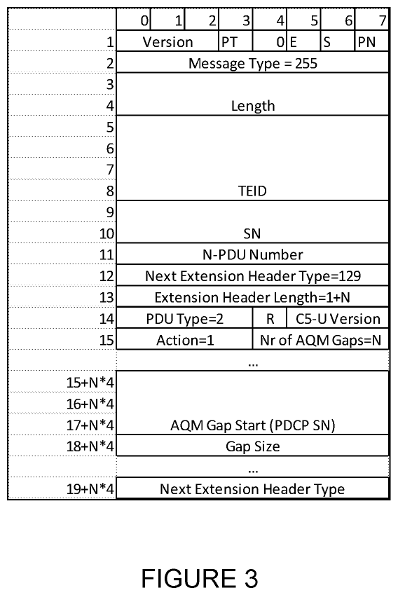

FIG. 2 depicts a discard indication specifying that all PDCP PDU's up to a particular PDCP SN shall be discarded and FIG. 3 specifies one or a number of blocks of PDCP SN to discard.

FIGS. 2 and 3 below are example embodiments, other combinations of data fields can be used, such as reserved bits or other “Next Extended Header Type” or “PDU Type” values to convey the same discard indications as outlined in the FIGS. 2 and 3 examples. In addition, there are alternative embodiments to convey the discard indication via either a PDCP or a GTP-U PDU utilizing the same principle of utilizing undefined values in existing header value ranges or parameter fields or reserved bits.

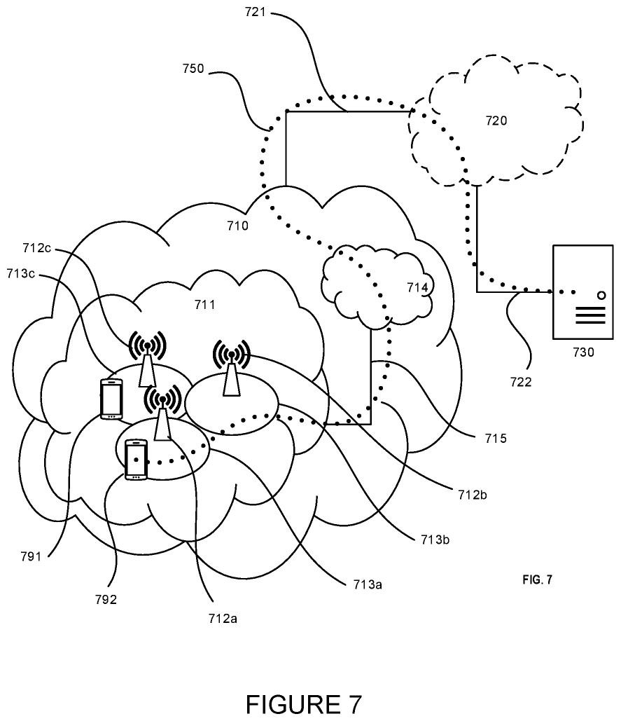

FIG. 4 is an example wireless network, according to certain embodiments in accordance with certain embodiments. Although the subject matter described herein may be implemented in any appropriate type of system using any suitable components, the embodiments disclosed herein are described in relation to a wireless network, such as the example wireless network illustrated in FIG. 4. For simplicity, the wireless network of FIG. 4 only depicts network 406, network nodes 460 and 460b, and WDs 410, 410b, and 410c. In practice, a wireless network may further include any additional elements suitable to support communication between wireless devices or between a wireless device and another communication device, such as a landline telephone, a service provider, or any other network node or end device. Of the illustrated components, network node 460 and wireless device (WD) 410 are depicted with additional detail. In certain embodiments, the network node 460 may be the DU disclosed in FIG. 1. In some embodiments, the network node 460 may be a base station which is further depicted in FIGS. 7 to 13 and 15. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 406 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 460 and WD 410 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 4, network node 460 includes processing circuitry 470, device readable medium 480, interface 490, auxiliary equipment 484, power source 486, power circuitry 487, and antenna 462. Although network node 460 illustrated in the example wireless network of FIG. 4 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 460 are depicted as single boxes located within a larger box, or nested within multiple boxes, in practice, a network node may comprise multiple different physical components that make up a single illustrated component (e.g., device readable medium 480 may comprise multiple separate hard drives as well as multiple RAM modules).

Similarly, network node 460 may be composed of multiple physically separate components (e.g., a NodeB component and a RNC component, or a BTS component and a BSC component, etc.), which may each have their own respective components. In certain scenarios in which network node 460 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 460 may be configured to support multiple radio access technologies (RATs). In such embodiments, some components may be duplicated (e.g., separate device readable medium 480 for the different RATs) and some components may be reused (e.g., the same antenna 462 may be shared by the RATs). In some embodiments, network node 460 may carry out the functions of the CU described with respect to FIG. 1 and FIG. 14. Network node 460 may also include multiple sets of the various illustrated components for different wireless technologies integrated into network node 460, such as, for example, GSM, WCDMA, LTE, NR, WiFi, or Bluetooth wireless technologies. These wireless technologies may be integrated into the same or different chip or set of chips and other components within network node 460.

Processing circuitry 470 is configured to perform any determining, calculating, or similar operations (e.g., certain obtaining operations) described herein as being provided by a network node. These operations performed by processing circuitry 470 may include processing information obtained by processing circuitry 470 by, for example, converting the obtained information into other information, comparing the obtained information or converted information to information stored in the network node, and/or performing one or more operations based on the obtained information or converted information, and as a result of said processing making a determination.

Processing circuitry 470 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 460 components, such as device readable medium 480, network node 460 functionality. For example, processing circuitry 470 may execute instructions stored in device readable medium 480 or in memory within processing circuitry 470. Such functionality may include providing any of the various wireless features, functions, or benefits discussed herein. In some embodiments, processing circuitry 470 may include a system on a chip (SOC).

In some embodiments, processing circuitry 470 may include one or more of radio frequency (RF) transceiver circuitry 472 and baseband processing circuitry 474. In some embodiments, radio frequency (RF) transceiver circuitry 472 and baseband processing circuitry 474 may be on separate chips (or sets of chips), boards, or units, such as radio units and digital units. In alternative embodiments, part or all of RF transceiver circuitry 472 and baseband processing circuitry 474 may be on the same chip or set of chips, boards, or units

In certain embodiments, some or all of the functionality described herein as being provided by a network node, base station, eNB or other such network device may be performed by processing circuitry 470 executing instructions stored on device readable medium 480 or memory within processing circuitry 470. In alternative embodiments, some or all of the functionality may be provided by processing circuitry 470 without executing instructions stored on a separate or discrete device readable medium, such as in a hard-wired manner. In any of those embodiments, whether executing instructions stored on a device readable storage medium or not, processing circuitry 470 can be configured to perform the described functionality. The benefits provided by such functionality are not limited to processing circuitry 470 alone or to other components of network node 460, but are enjoyed by network node 460 as a whole, and/or by end users and the wireless network generally.

Device readable medium 480 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 470. Device readable medium 480 may store any suitable instructions, data or information, including a computer program, software, an application including one or more of logic, rules, code, tables, etc. and/or other instructions capable of being executed by processing circuitry 470 and, utilized by network node 460. Device readable medium 480 may be used to store any calculations made by processing circuitry 470 and/or any data received via interface 490. In some embodiments, processing circuitry 470 and device readable medium 480 may be considered to be integrated.

Interface 490 is used in the wired or wireless communication of signalling and/or data between network node 460, network 406, and/or WDs 410. As illustrated, interface 490 comprises port(s)/terminal(s) 494 to send and receive data, for example to and from network 406 over a wired connection. Interface 490 also includes radio front end circuitry 492 that may be coupled to, or in certain embodiments a part of, antenna 462. Radio front end circuitry 492 comprises filters 498 and amplifiers 496. Radio front end circuitry 492 may be connected to antenna 462 and processing circuitry 470. Radio front end circuitry may be configured to condition signals communicated between antenna 462 and processing circuitry 470. Radio front end circuitry 492 may receive digital data that is to be sent out to other network nodes or WDs via a wireless connection. Radio front end circuitry 492 may convert the digital data into a radio signal having the appropriate channel and bandwidth parameters using a combination of filters 498 and/or amplifiers 496. The radio signal may then be transmitted via antenna 462. Similarly, when receiving data, antenna 462 may collect radio signals which are then converted into digital data by radio front end circuitry 492. The digital data may be passed to processing circuitry 470. In other embodiments, the interface may comprise different components and/or different combinations of components.

In certain alternative embodiments, network node 460 may not include separate radio front end circuitry 492, instead, processing circuitry 470 may comprise radio front end circuitry and may be connected to antenna 462 without separate radio front end circuitry 492. Similarly, in some embodiments, all or some of RF transceiver circuitry 472 may be considered a part of interface 490. In still other embodiments, interface 490 may include one or more ports or terminals 494, radio front end circuitry 492, and RF transceiver circuitry 472, as part of a radio unit (not shown), and interface 490 may communicate with baseband processing circuitry 474, which is part of a digital unit (not shown).

Antenna 462 may include one or more antennas, or antenna arrays, configured to send and/or receive wireless signals. Antenna 462 may be coupled to radio front end circuitry 490 and may be any type of antenna capable of transmitting and receiving data and/or signals wirelessly. In some embodiments, antenna 462 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 462 may be separate from network node 460 and may be connectable to network node 460 through an interface or port.

Antenna 462, interface 490, and/or processing circuitry 470 may be configured to perform any receiving operations and/or certain obtaining operations described herein as being performed by a network node. Any information, data and/or signals may be received from a wireless device, another network node and/or any other network equipment. Similarly, antenna 462, interface 490, and/or processing circuitry 470 may be configured to perform any transmitting operations described herein as being performed by a network node. Any information, data and/or signals may be transmitted to a wireless device, another network node and/or any other network equipment.

Power circuitry 487 may comprise, or be coupled to, power management circuitry and is configured to supply the components of network node 460 with power for performing the functionality described herein. Power circuitry 487 may receive power from power source 486. Power source 486 and/or power circuitry 487 may be configured to provide power to the various components of network node 460 in a form suitable for the respective components (e.g., at a voltage and current level needed for each respective component). Power source 486 may either be included in, or external to, power circuitry 487 and/or network node 460. For example, network node 460 may be connectable to an external power source (e.g., an electricity outlet) via an input circuitry or interface such as an electrical cable, whereby the external power source supplies power to power circuitry 487. As a further example, power source 486 may comprise a source of power in the form of a battery or battery pack which is connected to, or integrated in, power circuitry 487. The battery may provide backup power should the external power source fail. Other types of power sources, such as photovoltaic devices, may also be used.

Alternative embodiments of network node 460 may include additional components beyond those shown in FIG. 4 that may be responsible for providing certain aspects of the network node's functionality, including any of the functionality described herein and/or any functionality necessary to support the subject matter described herein. For example, network node 460 may include user interface equipment to allow input of information into network node 460 and to allow output of information from network node 460. This may allow a user to perform diagnostic, maintenance, repair, and other administrative functions for network node 460.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 410 includes antenna 411, interface 414, processing circuitry 420, device readable medium 430, user interface equipment 432, auxiliary equipment 434, power source 436 and power circuitry 437. WD 410 may include multiple sets of one or more of the illustrated components for different wireless technologies supported by WD 410, such as, for example, GSM, WCDMA, LTE, NR, WiFi, WiMAX, or Bluetooth wireless technologies, just to mention a few. These wireless technologies may be integrated into the same or different chips or set of chips as other components within WD 410.

Antenna 411 may include one or more antennas or antenna arrays, configured to send and/or receive wireless signals, and is connected to interface 414. In certain alternative embodiments, antenna 411 may be separate from WD 410 and be connectable to WD 410 through an interface or port. Antenna 411, interface 414, and/or processing circuitry 420 may be configured to perform any receiving or transmitting operations described herein as being performed by a WD. Any information, data and/or signals may be received from a network node and/or another WD. In some embodiments, radio front end circuitry and/or antenna 411 may be considered an interface.

As illustrated, interface 414 comprises radio front end circuitry 412 and antenna 411. Radio front end circuitry 412 comprise one or more filters 418 and amplifiers 416. Radio front end circuitry 414 is connected to antenna 411 and processing circuitry 420, and is configured to condition signals communicated between antenna 411 and processing circuitry 420. Radio front end circuitry 412 may be coupled to or a part of antenna 411. In some embodiments, WD 410 may not include separate radio front end circuitry 412; rather, processing circuitry 420 may comprise radio front end circuitry and may be connected to antenna 411. Similarly, in some embodiments, some or all of RF transceiver circuitry 422 may be considered a part of interface 414. Radio front end circuitry 412 may receive digital data that is to be sent out to other network nodes or WDs via a wireless connection. Radio front end circuitry 412 may convert the digital data into a radio signal having the appropriate channel and bandwidth parameters using a combination of filters 418 and/or amplifiers 416. The radio signal may then be transmitted via antenna 411. Similarly, when receiving data, antenna 411 may collect radio signals which are then converted into digital data by radio front end circuitry 412. The digital data may be passed to processing circuitry 420. In other embodiments, the interface may comprise different components and/or different combinations of components.

Processing circuitry 420 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 410 components, such as device readable medium 430, WD 410 functionality. Such functionality may include providing any of the various wireless features or benefits discussed herein. For example, processing circuitry 420 may execute instructions stored in device readable medium 430 or in memory within processing circuitry 420 to provide the functionality disclosed herein.

As illustrated, processing circuitry 420 includes one or more of RF transceiver circuitry 422, baseband processing circuitry 424, and application processing circuitry 426. In other embodiments, the processing circuitry may comprise different components and/or different combinations of components. In certain embodiments processing circuitry 420 of WD 410 may comprise a SOC. In some embodiments, RF transceiver circuitry 422, baseband processing circuitry 424, and application processing circuitry 426 may be on separate chips or sets of chips. In alternative embodiments, part or all of baseband processing circuitry 424 and application processing circuitry 426 may be combined into one chip or set of chips, and RF transceiver circuitry 422 may be on a separate chip or set of chips. In still alternative embodiments, part or all of RF transceiver circuitry 422 and baseband processing circuitry 424 may be on the same chip or set of chips, and application processing circuitry 426 may be on a separate chip or set of chips. In yet other alternative embodiments, part or all of RF transceiver circuitry 422, baseband processing circuitry 424, and application processing circuitry 426 may be combined in the same chip or set of chips. In some embodiments, RF transceiver circuitry 422 may be a part of interface 414. RF transceiver circuitry 422 may condition RF signals for processing circuitry 420.

In certain embodiments, some or all of the functionalities described herein as being performed by a WD may be provided by processing circuitry 420 executing instructions stored on device readable medium 430, which in certain embodiments may be a computer-readable storage medium. In alternative embodiments, some or all of the functionality may be provided by processing circuitry 420 without executing instructions stored on a separate or discrete device readable storage medium, such as in a hard-wired manner. In any of those particular embodiments, whether executing instructions stored on a device readable storage medium or not, processing circuitry 420 can be configured to perform the described functionality. The benefits provided by such functionality are not limited to processing circuitry 420 alone or to other components of WD 410, but are enjoyed by WD 410 as a whole, and/or by end users and the wireless network generally.

Processing circuitry 420 may be configured to perform any determining, calculating, or similar operations (e.g., certain obtaining operations) described herein as being performed by a WD. These operations, as performed by processing circuitry 420, may include processing information obtained by processing circuitry 420 by, for example, converting the obtained information into other information, comparing the obtained information or converted information to information stored by WD 410, and/or performing one or more operations based on the obtained information or converted information, and as a result of said processing making a determination.

Device readable medium 430 may be operable to store a computer program, software, an application including one or more of logic, rules, code, tables, etc. and/or other instructions capable of being executed by processing circuitry 420. Device readable medium 430 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 420. In some embodiments, processing circuitry 420 and device readable medium 430 may be considered to be integrated.

User interface equipment 432 may provide components that allow for a human user to interact with WD 410. Such interaction may be of many forms, such as visual, audial, tactile, etc. User interface equipment 432 may be operable to produce output to the user and to allow the user to provide input to WD 410. The type of interaction may vary depending on the type of user interface equipment 432 installed in WD 410. For example, if WD 410 is a smart phone, the interaction may be via a touch screen; if WD 410 is a smart meter, the interaction may be through a screen that provides usage (e.g., the number of gallons used) or a speaker that provides an audible alert (e.g., if smoke is detected). User interface equipment 432 may include input interfaces, devices and circuits, and output interfaces, devices and circuits. User interface equipment 432 is configured to allow input of information into WD 410, and is connected to processing circuitry 420 to allow processing circuitry 420 to process the input information. User interface equipment 432 may include, for example, a microphone, a proximity or other sensor, keys/buttons, a touch display, one or more cameras, a USB port, or other input circuitry. User interface equipment 432 is also configured to allow output of information from WD 410, and to allow processing circuitry 420 to output information from WD 410. User interface equipment 432 may include, for example, a speaker, a display, vibrating circuitry, a USB port, a headphone interface, or other output circuitry. Using one or more input and output interfaces, devices, and circuits, of user interface equipment 432, WD 410 may communicate with end users and/or the wireless network, and allow them to benefit from the functionality described herein.

Auxiliary equipment 434 is operable to provide more specific functionality which may not be generally performed by WDs. This may comprise specialized sensors for doing measurements for various purposes, interfaces for additional types of communication such as wired communications etc. The inclusion and type of components of auxiliary equipment 434 may vary depending on the embodiment and/or scenario.

Power source 436 may, in some embodiments, be in the form of a battery or battery pack. Other types of power sources, such as an external power source (e.g., an electricity outlet), photovoltaic devices or power cells, may also be used. WD 410 may further comprise power circuitry 437 for delivering power from power source 436 to the various parts of WD 410 which need power from power source 436 to carry out any functionality described or indicated herein. Power circuitry 437 may in certain embodiments comprise power management circuitry. Power circuitry 437 may additionally or alternatively be operable to receive power from an external power source; in which case WD 410 may be connectable to the external power source (such as an electricity outlet) via input circuitry or an interface such as an electrical power cable. Power circuitry 437 may also in certain embodiments be operable to deliver power from an external power source to power source 436. This may be, for example, for the charging of power source 436. Power circuitry 437 may perform any formatting, converting, or other modification to the power from power source 436 to make the power suitable for the respective components of WD 410 to which power is supplied.

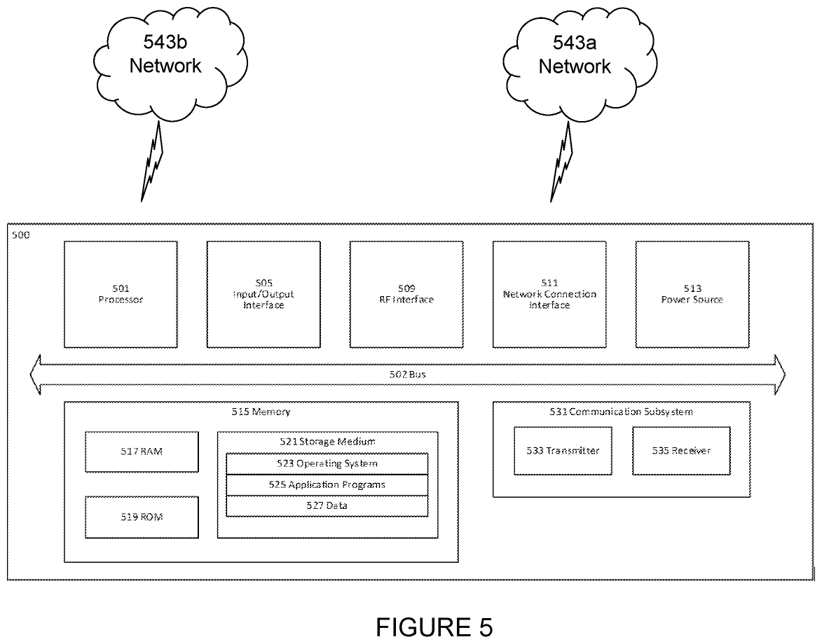

FIG. 5 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 5200 may be any UE identified by the 3rd Generation Partnership Project (3GPP), including a NB-IoT UE, a machine type communication (MTC) UE, and/or an enhanced MTC (eMTC) UE. UE 500, as illustrated in FIG. 5, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 5 is a UE, the components discussed herein are equally applicable to a WD, and vice-versa.

In FIG. 5, UE 500 includes processing circuitry 501 that is operatively coupled to input/output interface 505, radio frequency (RF) interface 509, network connection interface 511, memory 515 including random access memory (RAM) 517, read-only memory (ROM) 519, and storage medium 521 or the like, communication subsystem 531, power source 533, and/or any other component, or any combination thereof. Storage medium 521 includes operating system 523, application program 525, and data 527. In other embodiments, storage medium 521 may include other similar types of information. Certain UEs may utilize all of the components shown in FIG. 5, or only a subset of the components. The level of integration between the components may vary from one UE to another UE. Further, certain UEs may contain multiple instances of a component, such as multiple processors, memories, transceivers, transmitters, receivers, etc.

In FIG. 5, processing circuitry 501 may be configured to process computer instructions and data. Processing circuitry 501 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 501 may include two central processing units (CPUs). Data may be information in a form suitable for use by a computer.

In the depicted embodiment, input/output interface 505 may be configured to provide a communication interface to an input device, output device, or input and output device. UE 500 may be configured to use an output device via input/output interface 505. An output device may use the same type of interface port as an input device. For example, a USB port may be used to provide input to and output from UE 500. The output device may be a speaker, a sound card, a video card, a display, a monitor, a printer, an actuator, an emitter, a smartcard, another output device, or any combination thereof. UE 500 may be configured to use an input device via input/output interface 505 to allow a user to capture information into UE 500. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 5, RF interface 509 may be configured to provide a communication interface to RF components such as a transmitter, a receiver, and an antenna. Network connection interface 511 may be configured to provide a communication interface to network 543a. Network 543a may encompass wired and/or wireless networks such as a local-area network (LAN), a wide-area network (WAN), a computer network, a wireless network, a telecommunications network, another like network or any combination thereof. For example, network 543a may comprise a Wi-Fi network. Network connection interface 511 may be configured to include a receiver and a transmitter interface used to communicate with one or more other devices over a communication network according to one or more communication protocols, such as Ethernet, TCP/IP, SONET, ATM, or the like. Network connection interface 511 may implement receiver and transmitter functionality appropriate to the communication network links (e.g., optical, electrical, and the like). The transmitter and receiver functions may share circuit components, software or firmware, or alternatively may be implemented separately.

RAM 517 may be configured to interface via bus 502 to processing circuitry 501 to provide storage or caching of data or computer instructions during the execution of software programs such as the operating system, application programs, and device drivers. ROM 519 may be configured to provide computer instructions or data to processing circuitry 501. For example, ROM 519 may be configured to store invariant low-level system code or data for basic system functions such as basic input and output (I/O), startup, or reception of keystrokes from a keyboard that are stored in a non-volatile memory. Storage medium 521 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 521 may be configured to include operating system 523, application program 525 such as a web browser application, a widget or gadget engine or another application, and data file 527. Storage medium 521 may store, for use by UE 500, any of a variety of various operating systems or combinations of operating systems.

Storage medium 521 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 521 may allow UE 500 to access computer-executable instructions, application programs or the like, stored on transitory or non-transitory memory media, to off-load data, or to upload data. An article of manufacture, such as one utilizing a communication system may be tangibly embodied in storage medium 521, which may comprise a device readable medium.

In FIG. 5, processing circuitry 501 may be configured to communicate with network 543b using communication subsystem 531. Network 543a and network 543b may be the same network or networks or different network or networks. Communication subsystem 531 may be configured to include one or more transceivers used to communicate with network 543b. For example, communication subsystem 531 may be configured to include one or more transceivers used to communicate with one or more remote transceivers of another device capable of wireless communication such as another WD, UE, or base station of a radio access network (RAN) according to one or more communication protocols, such as IEEE 802.5, CDMA, WCDMA, GSM, LTE, UTRAN, WiMax, or the like. Each transceiver may include transmitter 533 and/or receiver 535 to implement transmitter or receiver functionality, respectively, appropriate to the RAN links (e.g., frequency allocations and the like). Further, transmitter 533 and receiver 535 of each transceiver may share circuit components, software or firmware, or alternatively may be implemented separately.

In the illustrated embodiment, the communication functions of communication subsystem 531 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 531 may include cellular communication, Wi-Fi communication, Bluetooth communication, and GPS communication. Network 543b may encompass wired and/or wireless networks such as a local-area network (LAN), a wide-area network (WAN), a computer network, a wireless network, a telecommunications network, another like network or any combination thereof. For example, network 543b may be a cellular network, a Wi-Fi network, and/or a near-field network. Power source 513 may be configured to provide alternating current (AC) or direct current (DC) power to components of UE 500.

The features, benefits and/or functions described herein may be implemented in one of the components of UE 500 or partitioned across multiple components of UE 500. Further, the features, benefits, and/or functions described herein may be implemented in any combination of hardware, software or firmware. In one example, communication subsystem 531 may be configured to include any of the components described herein. Further, processing circuitry 501 may be configured to communicate with any of such components over bus 502. In another example, any of such components may be represented by program instructions stored in memory that when executed by processing circuitry 501 perform the corresponding functions described herein. In another example, the functionality of any of such components may be partitioned between processing circuitry 501 and communication subsystem 531. In another example, the non-computationally intensive functions of any of such components may be implemented in software or firmware and the computationally intensive functions may be implemented in hardware.

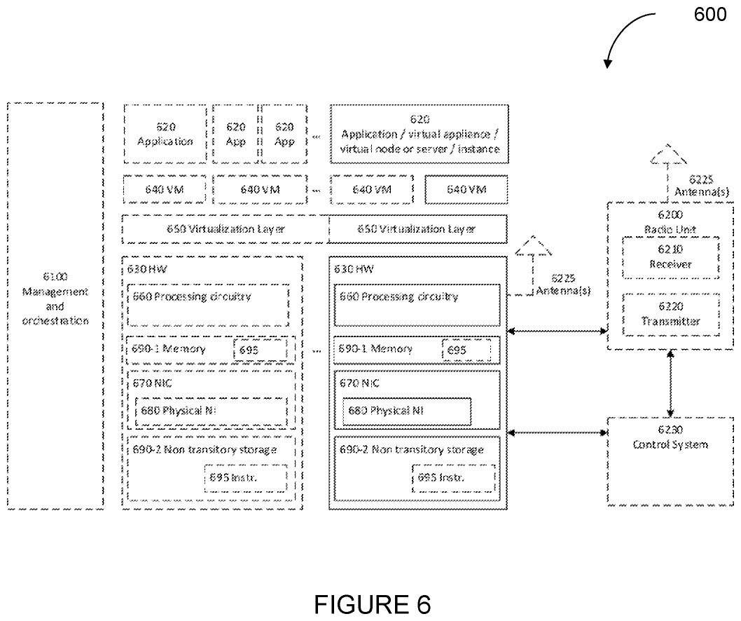

FIG. 6 illustrates an example virtualization environment, according to certain embodiments. FIG. 6 is a schematic block diagram illustrating a virtualization environment 600 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 600 hosted by one or more of hardware nodes 630. Further, in embodiments in which the virtual node is not a radio access node or does not require radio connectivity (e.g., a core network node), then the network node may be entirely virtualized.

The functions may be implemented by one or more applications 620 (which may alternatively be called software instances, virtual appliances, network functions, virtual nodes, virtual network functions, etc.) operative to implement some of the features, functions, and/or benefits of some of the embodiments disclosed herein. Applications 620 are run in virtualization environment 600 which provides hardware 630 comprising processing circuitry 660 and memory 690. Memory 690 contains instructions 695 executable by processing circuitry 660 whereby application 620 is operative to provide one or more of the features, benefits, and/or functions disclosed herein.

Virtualization environment 600, comprises general-purpose or special-purpose network hardware devices 630 comprising a set of one or more processors or processing circuitry 660, which may be commercial off-the-shelf (COTS) processors, dedicated Application Specific Integrated Circuits (ASICs), or any other type of processing circuitry including digital or analog hardware components or special purpose processors. Each hardware device may comprise memory 690-1 which may be non-persistent memory for temporarily storing instructions 695 or software executed by processing circuitry 660. Each hardware device may comprise one or more network interface controllers (NICs) 670, also known as network interface cards, which include physical network interface 680. Each hardware device may also include non-transitory, persistent, machine-readable storage media 690-2 having stored therein software 695 and/or instructions executable by processing circuitry 660. Software 695 may include any type of software including software for instantiating one or more virtualization layers 650 (also referred to as hypervisors), software to execute virtual machines 640 as well as software allowing it to execute functions, features and/or benefits described in relation with some embodiments described herein.

Virtual machines 640, comprise virtual processing, virtual memory, virtual networking or interface and virtual storage, and may be run by a corresponding virtualization layer 650 or hypervisor. Different embodiments of the instance of virtual appliance 620 may be implemented on one or more of virtual machines 640, and the implementations may be made in different ways.

During operation, processing circuitry 660 executes software 695 to instantiate the hypervisor or virtualization layer 650, which may sometimes be referred to as a virtual machine monitor (VMM). Virtualization layer 650 may present a virtual operating platform that appears like networking hardware to virtual machine 640.

As shown in FIG. 6, hardware 630 may be a standalone network node with generic or specific components. Hardware 630 may comprise antenna 6225 and may implement some functions via virtualization. Alternatively, hardware 630 may be part of a larger cluster of hardware (e.g. such as in a data center or customer premise equipment (CPE)) where many hardware nodes work together and are managed via management and orchestration (MANO) 6100, which, among others, oversees lifecycle management of applications 620.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 640 may be a software implementation of a physical machine that runs programs as if they were executing on a physical, non-virtualized machine. Each of virtual machines 640, and that part of hardware 630 that executes that virtual machine, be it hardware dedicated to that virtual machine and/or hardware shared by that virtual machine with others of the virtual machines 640, forms a separate virtual network elements (VNE).

Still in the context of NFV, Virtual Network Function (VNF) is responsible for handling specific network functions that run in one or more virtual machines 640 on top of hardware networking infrastructure 630 and corresponds to application 620 in FIG. 6.

In some embodiments, one or more radio units 6200 that each include one or more transmitters 6220 and one or more receivers 6210 may be coupled to one or more antennas 6225. Radio units 6200 may communicate directly with hardware nodes 630 via one or more appropriate network interfaces and may be used in combination with the virtual components to provide a virtual node with radio capabilities, such as a radio access node or a base station.

In some embodiments, some signaling can be affected with the use of control system 6230 which may alternatively be used for communication between the hardware nodes 630 and radio units 6200.

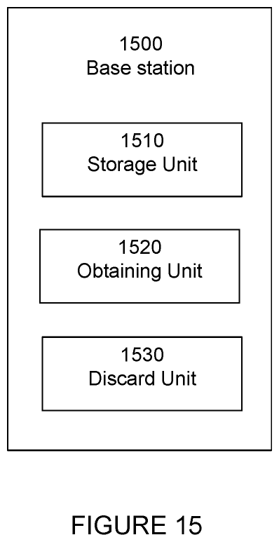

FIG. 7 illustrates an example telecommunication network connected via an intermediate network to a host computer, according to certain embodiments. With reference to FIG. 7, in accordance with an embodiment, a communication system includes telecommunication network 710, such as a 3GPP-type cellular network, which comprises access network 711, such as a radio access network, and core network 714. Access network 711 comprises a plurality of base stations 712a, 712b, 712c, such as NBs, eNBs, gNBs or other types of wireless access points, each defining a corresponding coverage area 713a, 713b, 713c. In certain embodiments, the plurality of base stations 712a, 712b, 712c may perform the functionality of the DU as described with respect to FIGS. 1 and 15. In some embodiments, the plurality of base stations 712a, 712b, 712c may also or instead perform the functionality of a CU as described herein. Each base station 712a, 712b, 712c is connectable to core network 714 over a wired or wireless connection 715. A first UE 791 located in coverage area 713c is configured to wirelessly connect to, or be paged by, the corresponding base station 712c. A second UE 792 in coverage area 713a is wirelessly connectable to the corresponding base station 712a. While a plurality of UEs 791, 792 are illustrated in this example, the disclosed embodiments are equally applicable to a situation where a sole UE is in the coverage area or where a sole UE is connecting to the corresponding base station 712.

Telecommunication network 710 is itself connected to host computer 730, which may be embodied in the hardware and/or software of a standalone server, a cloud-implemented server, a distributed server or as processing resources in a server farm. Host computer 730 may be under the ownership or control of a service provider, or may be operated by the service provider or on behalf of the service provider. Connections 721 and 722 between telecommunication network 710 and host computer 730 may extend directly from core network 714 to host computer 730 or may go via an optional intermediate network 720. Intermediate network 720 may be one of, or a combination of more than one of, a public, private or hosted network; intermediate network 720, if any, may be a backbone network or the Internet; in particular, intermediate network 720 may comprise two or more sub-networks (not shown).

The communication system of FIG. 7 as a whole enables connectivity between the connected UEs 791, 792 and host computer 730. The connectivity may be described as an over-the-top (OTT) connection 750. Host computer 730 and the connected UEs 791, 792 are configured to communicate data and/or signaling via OTT connection 750, using access network 711, core network 714, any intermediate network 720 and possible further infrastructure (not shown) as intermediaries. OTT connection 750 may be transparent in the sense that the participating communication devices through which OTT connection 750 passes are unaware of routing of uplink and downlink communications. For example, base station 712 may not or need not be informed about the past routing of an incoming downlink communication with data originating from host computer 730 to be forwarded (e.g., handed over) to a connected UE 791. Similarly, base station 712 need not be aware of the future routing of an outgoing uplink communication originating from the UE 791 towards the host computer 730.

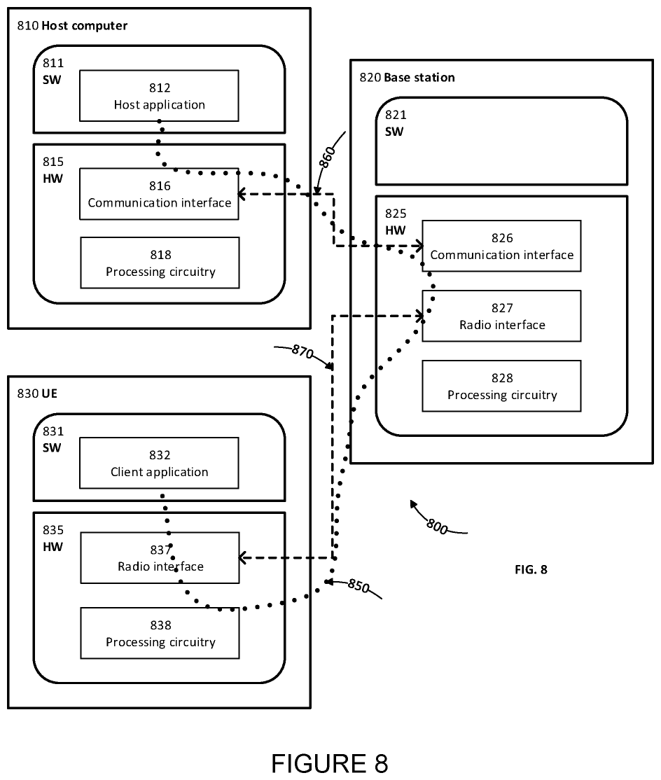

FIG. 8 illustrates an example host computer communicating via a base station with a user equipment over a partially wireless connection, in accordance with some embodiments. Example implementations, in accordance with an embodiment, of the UE, base station and host computer discussed in the preceding paragraphs will now be described with reference to FIG. 8. In communication system 800, host computer 810 comprises hardware 815 including communication interface 816 configured to set up and maintain a wired or wireless connection with an interface of a different communication device of communication system 800. Host computer 810 further comprises processing circuitry 818, which may have storage and/or processing capabilities. In particular, processing circuitry 818 may comprise one or more programmable processors, application-specific integrated circuits, field programmable gate arrays or combinations of these (not shown) adapted to execute instructions. Host computer 810 further comprises software 811, which is stored in or accessible by host computer 810 and executable by processing circuitry 818. Software 811 includes host application 812. Host application 812 may be operable to provide a service to a remote user, such as UE 830 connecting via OTT connection 850 terminating at UE 830 and host computer 810. In providing the service to the remote user, host application 812 may provide user data which is transmitted using OTT connection 850.

Communication system 800 further includes base station 820 provided in a telecommunication system and comprising hardware 825 enabling it to communicate with host computer 810 and with UE 830. In certain embodiments, the base station 820 may be a DU DU depicted in FIGS. 1 and 15. Hardware 825 may include communication interface 826 for setting up and maintaining a wired or wireless connection with an interface of a different communication device of communication system 800, as well as radio interface 827 for setting up and maintaining at least wireless connection 870 with UE 830 located in a coverage area (not shown in FIG. 8) served by base station 820. Communication interface 826 may be configured to facilitate connection 860 to host computer 810. Connection 860 may be direct, or it may pass through a core network (not shown in FIG. 8) of the telecommunication system and/or through one or more intermediate networks outside the telecommunication system. In the embodiment shown, hardware 825 of base station 820 further includes processing circuitry 828, which may comprise one or more programmable processors, application-specific integrated circuits, field programmable gate arrays or combinations of these (not shown) adapted to execute instructions. In another embodiment, hardware 825 of base station 820 further includes another processing circuitry to perform the functions of a CU. In some embodiments, base station 820 may comprise a component of CU. Base station 820 further has software 821 stored internally or accessible via an external connection. A further description of a base station 820 in accordance with some embodiments is illustrated in FIG. 15.

Communication system 800 further includes UE 830 already referred to. Its hardware 835 may include radio interface 837 configured to set up and maintain wireless connection 870 with a base station serving a coverage area in which UE 830 is currently located. Hardware 835 of UE 830 further includes processing circuitry 838, which may comprise one or more programmable processors, application-specific integrated circuits, field programmable gate arrays or combinations of these (not shown) adapted to execute instructions. UE 830 further comprises software 831, which is stored in or accessible by UE 830 and executable by processing circuitry 838. Software 831 includes client application 832. Client application 832 may be operable to provide a service to a human or non-human user via UE 830, with the support of host computer 810. In host computer 810, an executing host application 812 may communicate with the executing client application 832 via OTT connection 850 terminating at UE 830 and host computer 810. In providing the service to the user, client application 832 may receive request data from host application 812 and provide user data in response to the request data. OTT connection 850 may transfer both the request data and the user data. Client application 832 may interact with the user to generate the user data that it provides.

It is noted that host computer 810, base station 820 and UE 830 illustrated in FIG. 8 may be similar or identical to host computer 730, one of base stations 712a, 712b, 712c and one of UEs 791, 792 of FIG. 7, respectively. This is to say, the inner workings of these entities may be as shown in FIG. 8 and independently, the surrounding network topology may be that of FIG. 7.

In FIG. 8, OTT connection 850 has been drawn abstractly to illustrate the communication between host computer 810 and UE 830 via base station 820, without explicit reference to any intermediary devices and the precise routing of messages via these devices. Network infrastructure may determine the routing, which it may be configured to hide from UE 830 or from the service provider operating host computer 810, or both. While OTT connection 850 is active, the network infrastructure may further take decisions by which it dynamically changes the routing (e.g., on the basis of load balancing consideration or reconfiguration of the network).

Wireless connection 870 between UE 830 and base station 820 is in accordance with the teachings of the embodiments described throughout this disclosure. One or more of the various embodiments improve the performance of OTT services provided to UE 830 using OTT connection 850, in which wireless connection 870 forms the last segment. More precisely, the teachings of these embodiments may improve the handling of redundant data in the transmit buffer and thereby provide benefits such as improved efficiency in radio resource use (e.g., not transmitting redundant data) as well as reduced delay in receiving new data (e.g., by removing redundant data in the buffer, new data can be transmitted sooner).

A measurement procedure may be provided for the purpose of monitoring data rate, latency and other factors on which the one or more embodiments improve. There may further be an optional network functionality for reconfiguring OTT connection 850 between host computer 810 and UE 830, in response to variations in the measurement results. The measurement procedure and/or the network functionality for reconfiguring OTT connection 850 may be implemented in software 811 and hardware 815 of host computer 810 or in software 831 and hardware 835 of UE 830, or both. In embodiments, sensors (not shown) may be deployed in or in association with communication devices through which OTT connection 850 passes; the sensors may participate in the measurement procedure by supplying values of the monitored quantities exemplified above, or supplying values of other physical quantities from which software 811, 831 may compute or estimate the monitored quantities. The reconfiguring of OTT connection 850 may include message format, retransmission settings, preferred routing etc.; the reconfiguring need not affect base station 820, and it may be unknown or imperceptible to base station 820. Such procedures and functionalities may be known and practiced in the art. In certain embodiments, measurements may involve proprietary UE signaling facilitating host computer 810's measurements of throughput, propagation times, latency and the like. The measurements may be implemented in that software 811 and 831 causes messages to be transmitted, in particular empty or ‘dummy’ messages, using OTT connection 850 while it monitors propagation times, errors etc.

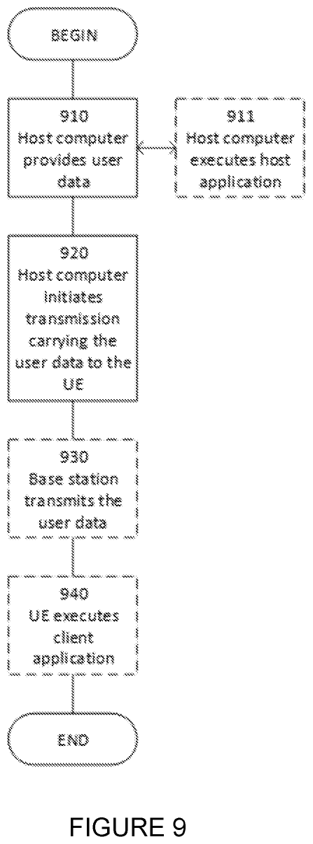

FIG. 9 illustrates an example method implemented in a communication system including a host computer, a base station and a user equipment, according to certain embodiments in accordance with some embodiments. More specifically, FIG. 9 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 9 will be included in this section. In step 910, the host computer provides user data. In substep 911 (which may be optional) of step 910, the host computer provides the user data by executing a host application. In step 920, the host computer initiates a transmission carrying the user data to the UE. In step 930 (which may be optional), the base station transmits to the UE the user data which was carried in the transmission that the host computer initiated, in accordance with the teachings of the embodiments described throughout this disclosure. In step 940 (which may also be optional), the UE executes a client application associated with the host application executed by the host computer.

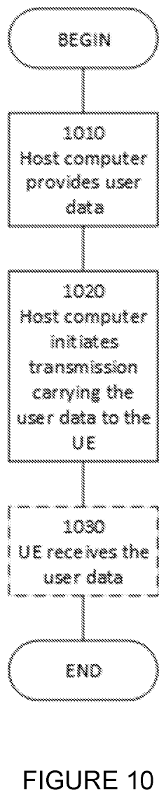

FIG. 10 illustrates an example method implemented in a communication system including a host computer, a base station and a user equipment, in accordance with some embodiments. More specifically, FIG. 10 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 10 will be included in this section. In step 1010 of the method, the host computer provides user data. In an optional substep (not shown) the host computer provides the user data by executing a host application. In step 1020, the host computer initiates a transmission carrying the user data to the UE. The transmission may pass via the base station, in accordance with the teachings of the embodiments described throughout this disclosure. In step 1030 (which may be optional), the UE receives the user data carried in the transmission.

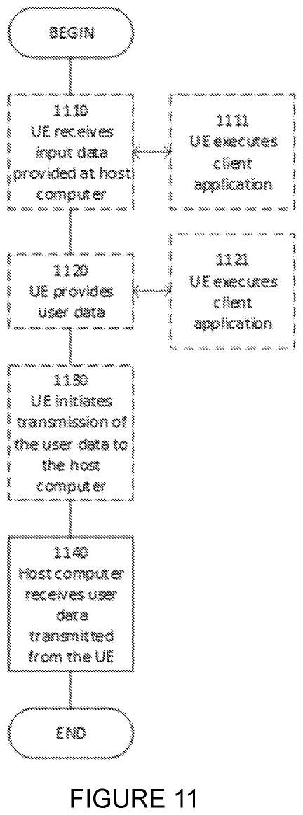

FIG. 11 illustrates another further example method implemented in a communication system including a host computer, a base station and a user equipment, in accordance with some embodiments. More specifically, FIG. 11 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 11 will be included in this section. In step 1110 (which may be optional), the UE receives input data provided by the host computer. Additionally or alternatively, in step 1120, the UE provides user data. In substep 1121 (which may be optional) of step 1120, the UE provides the user data by executing a client application. In substep 1111 (which may be optional) of step 1110, the UE executes a client application which provides the user data in reaction to the received input data provided by the host computer. In providing the user data, the executed client application may further consider user input received from the user. Regardless of the specific manner in which the user data was provided, the UE initiates, in substep 1130 (which may be optional), transmission of the user data to the host computer. In step 1140 of the method, the host computer receives the user data transmitted from the UE, in accordance with the teachings of the embodiments described throughout this disclosure.

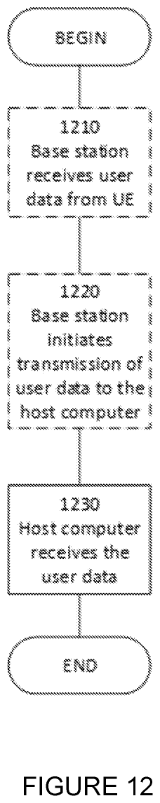

FIG. 12 illustrates another example method implemented in a communication system including a host computer, a base station and a user equipment, in accordance with some embodiments. More specifically, FIG. 12 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 12 will be included in this section. In step 1210 (which may be optional), in accordance with the teachings of the embodiments described throughout this disclosure, the base station receives user data from the UE. In step 1220 (which may be optional), the base station initiates transmission of the received user data to the host computer. In step 1230 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

FIG. 13 is a flow diagram of a method in a network node, in accordance with certain embodiments. Method 1300 begins at step 1310 with a network node storing data in a buffer memory, in some embodiments, the network node may a base station. In some embodiments, the network node may be the network node depicted in FIG. 4. In some embodiments, the network node may be the base station depicted in FIGS. 8 and 15. In some embodiments, the network node may be the DU depicted in FIG. 1. The data that is stored in the buffer memory is to be transmitted to a user equipment and is redundant to a second data stored at a second network node. In some embodiments, the second network node may be the network node depicted in FIG. 4. In some embodiments, the second network node may a base station. In some embodiments, the second network node may be the base station depicted in FIG. 8 and FIG. 15. In some embodiments, the second network node may be the DU depicted in FIG. 1. In certain embodiments, the data stored in the buffer memory is not redundant to the second data stored at the second network node. In some embodiments, the buffer memory may be used to store a plurality of data. Each piece of data of the plurality of data being stored in the buffer memory may have a number associated therewith. This may be used to identify the particular piece of data within the buffer memory. The size of a piece of data may vary depending on embodiment and protocols being used.

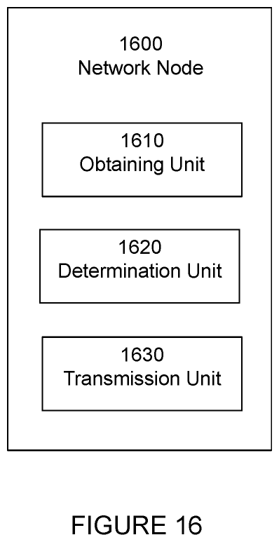

At step 1320, the network node obtains a discard message. In some embodiments, the discard message is obtained prior to the network node receiving an acknowledgement message from the UE. The acknowledgement message is typically used by the UE to indicate that the UE received the data. In some instances, the network node may never receive the acknowledgement message, because for the data, the UE may not send it, or may not send it to the network node. The discard message may be obtained from a third network node. In some embodiments, the third network node may be the CU depicted in FIGS. 1 and 16. In some embodiments, the discard message is obtained after an acknowledgement message is received by the third network node that the second data has been received by the UE. This acknowledgement message received by the third network node (e.g., a CU in some embodiments) may be received from a DU which has received a message from the UE indicating that the UE received the data. The acknowledgement message may be a PDCP ACK. The discard message may comprise a GPRS Tunneling Protocol User plane (GTP-U) packet data unit (PDU) sent by the third network node. The GTP-U PDU may comprise an indication within a Next Extension Header of the GTP-U PDU.

At step 1330, the network node discards the data from the buffer memory based on the discard message. The data may be discarded along with other data in the buffer memory. The data that is discarded may be identified based on the number associated with the respective piece of data. In some instances, the network node may discard all data in the buffer memory up to a specified number in the discard message. That is, if the data in the buffer memory is numbered 1-10 (actual numbering may vary between embodiments, but 1-10 is used as a matter of convenience), and the discard message indicates that all data up to number 4 is to be discarded, then the network node may discard data numbered 1, 2, 3, and 4. In some instances, the network node may discard specific pieces of data based on listed numbers of data to be discarded in the discard message. Returning to the example above, if the discard message indicates that data numbered 2, 5, and 7 is to be discarded, then the network node may discard data numbered 2, 5, and 7.

FIG. 14 is a flow diagram of another method in a network node, in accordance with certain embodiments. Method 1400 begins at step 1410 with the network node obtaining a transmission status feedback message. In some embodiments, the network node may be the CU depicted in FIG. 1. The transmission status feedback message may be obtained from a second network node. In some embodiments, the second network node may be the network node depicted in FIG. 4. In some embodiments, the second network node may be a base station. In some embodiments, the second network node may be the base station depicted in FIGS. 8 and 15. In some embodiments, the second network node may be the DU depicted in FIG. 1. The transmission status feedback message comprises an indication that the second network node delivered the redundant data to a UE (e.g., the data initially delivered to the UE by the second network node is not redundant, but the same data held by a third network node is redundant). In some embodiments, the transmission status feedback message is obtained from the third network node. In some embodiments, the third network node may be the network node depicted in FIG. 4. In some embodiments, the third network node may be a base station. In some embodiments, the third network node may be the base station depicted in FIG. 8 and FIG. 15. In some embodiments, the second network node may be the DU depicted in FIG. 1. For example, the transmission status feedback message comprises an indication that a wireless connection between the third network node and a UE has deteriorated. Because the connection has deteriorated, the second network node may send data to the UE. When the connection returns, the third network node may discard from its buffer memory the data that the second network node has sent to the UE.

At step 1420, the network node determines that a first buffer memory of the second network node contains a first data that is redundant to a second data stored in a second buffer memory of the third network node based on the transmission status feedback message. In certain embodiments, the network node determines a status of the first data stored in the second network node. In some embodiments, the network node determines a status of the second network node and/or the third network node. In some embodiments, the second network node uses a first radio access technology (e.g., LTE) and the third network node uses a second access technology (e.g., NR) which is different than the first access technology. In some embodiments, the second network node and the third network node are alternating in sending data to a user equipment. Using the example scenario from step 1306, both of the second network node and the third network node may have data 1-10, and the second network node may transmit the odd numbered data, and the third network node may transmit the even numbered data. Thus, when the second network node transmits data number 1, data number 1 stored by the third network node becomes redundant.

At step 1430, the network node sends a discard message to the second network node. The discard message comprises an indication that the second network node is to discard the redundant data. In certain embodiments, the discard message an indication to discard data stored in the second network node. In some embodiments, the network node sends a second discard message to the third network node, wherein the third network node is configured to ignore the discard message if the third network node has delivered the second data to a user equipment. The discard message may comprise a GPRS Tunneling Protocol User plane (GTP-U) packet data unit (PDU) sent by the third network node. The GTP-U PDU may comprise an indication within a Next Extension Header of the GTP-U PDU.

FIG. 15 is a schematic block diagram of an exemplary base station, in accordance with certain embodiments. The base station 1500 may be used in a wireless network (for example, the wireless network shown in FIG. 4). The base station 1500 may be implemented in a wireless device or network node (e.g., wireless device 410 or network node 460 shown in FIG. 4). Base station 1500 is operable to carry out the example method described with reference to FIG. 13, FIG. 14, and possibly any other processes or methods disclosed herein. It is also to be understood that the method of FIG. 13 and FIG. 14 is not necessarily carried out solely by base station 1500. At least some operations of the method can be performed by one or more other entities.

Base station 1500 may comprise processing circuitry, which may include one or more microprocessor or microcontrollers, as well as other digital hardware, which may include digital signal processors (DSPs), special-purpose digital logic, and the like. In some embodiments, the processing circuitry of base station 1500 may be the processing circuitry shown in FIG. 4. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause storage unit 1510, obtaining unit 1520, discard unit 1530, and any other suitable units of base station 1500 to perform corresponding functions according one or more embodiments of the present disclosure.

As illustrated in FIG. 15, base station 1500 includes storage unit 1510, obtaining unit 1520, and discard unit 1530. Storage unit 1510 may be configured to store a first data in a buffer memory. The first data that is stored in the buffer memory is data that is to be transmitted to a UE. In some embodiments, the buffer memory may be used to store a plurality of data. Each piece of data of the plurality of data being stored in the buffer may have a number associated therewith. This may be used to identify the particular piece of data within the buffer. The size of a piece of data may vary depending on embodiment and protocols being used.

Obtaining unit 1520 may be configured to obtain a discard message. The discard message is obtained prior to the base station receiving an acknowledgement message from the UE. The acknowledgement message is typically used by the UE to indicate that the UE received the first data. In some instances, the base station may never receive the acknowledgement message because for the first data, the UE may not have sent it, or may not send it to this base station. The discard message may be obtained from a network node. In some embodiments, the discard message is obtained after an acknowledgement message is received by a network node (e.g., DU and/or CU) that a second data stored at another base station has been received by the UE. The acknowledgement message may be a PDCP ACK. The discard message may comprise a GPRS Tunneling Protocol User plane (GTP-U) packet data unit (PDU) sent by the network node. The GTP-U PDU may comprise an indication within a Next Extension Header of the GTP-U PDU.

Discard unit 1530 may be configured to discard the first data from the buffer based on the discard message. The first data may be discarded along with other data in the buffer. The data that is discarded may be identified based on the number associated with the respective piece of data. In some instances, the base station may discard all data in the buffer up to a specified number in the discard message. That is, if the data in the buffer is numbered 1-10 (actual numbering may vary between embodiments, but 1-10 is used as a matter of convenience), and the discard message indicates that all data up to number 4 is to be discarded, then the base station may discard data numbers 1, 2, 3, and 4. In some instances, the base station may discard specific pieces of data based on listed numbers of data to be discarded in the discard message. Returning to the example above, if the discard message indicates that data numbered 2, 5, and 7 is to be discarded, then the base station may discard data numbers 2, 5, and 7.

FIG. 16 is a schematic block diagram of an exemplary network node, in accordance with certain embodiments. The network node 1600 may be used in a wireless network (for example, the wireless network shown in FIG. 4). The network node 1600 may be implemented in a wireless device (e.g., wireless device 410 shown in FIG. 4). The network node 1600 is operable to carry out the example method described with reference to FIG. 13, FIG. 14, and possibly any other processes or methods disclosed herein. It is also to be understood that the method of FIG. 13 and FIG. 14 is not necessarily carried out solely by base station 1500. At least some operations of the method can be performed by one or more other entities.

Network node 1600 may comprise processing circuitry, which may include one or more microprocessor or microcontrollers, as well as other digital hardware, which may include digital signal processors (DSPs), special-purpose digital logic, and the like. In some embodiments, the processing circuitry of base station 1500 may be the processing circuitry show in FIG. 4. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause obtaining unit 1610, determination unit 1620, transmission unit 1630, and any other suitable units of network node 1600 to perform corresponding functions according one or more embodiments of the present disclosure.

As illustrated in FIG. 16, network node 1600 includes obtaining unit 1610, determination unit 1620, and transmission unit 1630. Obtaining unit 1610 may be configured to obtain a transmission status feedback message. The transmission status feedback message may be obtained from a second base station. The transmission status feedback message comprises an indication that the second base station delivered the redundant data to a UE (e.g., the data initially delivered to the UE by the second base station is not redundant, but the same data held by the first base station is redundant). In some embodiments, the transmission status feedback message is obtained from the first base station. For example, the transmission status feedback message comprises an indication that a wireless connection between the first base station and a UE has deteriorated. Because the connection has deteriorated, the second base station may send data to the UE. When the connection returns, the first base station may discard from its buffer memory the data that the second base station has sent to the UE.

Determination unit 1620 may be configured to determine a first base station's buffer memory contains a first data that is redundant to a second data stored in a second buffer memory of the second base station based on the transmission status feedback message. In some embodiments, the network node sends a second discard message to the first base station, wherein the first base station is configured to ignore the discard message if first base station has delivered the second data to a user equipment. In some embodiments, the first base station uses a first radio access technology (e.g., LTE) and the second base station uses a second access technology (e.g., NR) different than the first access technology. In some embodiments, the first base station and the second base station are alternating in sending data to the UE. Using the example scenario from step 1306, both the first and second base stations may have data 1-10, and the first base station may transmit the odd numbered data, and the second base station may transmit the even numbered data. Thus, when the first base station transmits data number 1, data number 1 stored by the second base station becomes redundant.

Transmission unit 1630 may be configured to send a discard message to the first base station. The discard message may comprise an indication that the first base station is to discard the redundant data. The discard message may comprise a GPRS Tunneling Protocol User plane (GTP-U) packet data unit (PDU) sent by the third network node. The GTP-U PDU may comprise an indication within a Next Extension Header of the GTP-U PDU.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

According to various embodiments, an advantage of features herein is that redundant data can be discarded before it is transmitted over the air interface thus saving valuable bandwidth. Another advantage is that a DU that has a temporal loss of coverage can clear its buffer of redundant data and be ready to transmit new data as soon as coverage is restored.

While processes in the figures may show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method for use in a network node for buffer handling utilizing in-band control signaling, comprising:
storing, in a buffer memory, a plurality of data to be transmitted to a user equipment, each data of the plurality of data has an associated number, the plurality of data comprising first data to be transmitted to a user equipment, the first data having a first number associated therewith;
obtaining a discard message from a second network node, the discard message comprising the first number indicating that all data of the plurality of data up to the first number is to be discarded; and
discarding the first data and at least one additional data based on the discard message.

2. The method according to claim 1, wherein the first data is redundant to second data stored at a third network node.

3. The method according to claim 2, wherein the discard message comprises a GPRS Tunneling Protocol User plane packet data unit.

4. The method according to claim 3, wherein the GPRS Tunneling Protocol User plane packet data unit comprises an indication in a Next Extension Header of the GTP-U PDU.

5-7. (canceled)

8. The method according to claim 1, wherein the discard message is obtained after an acknowledgement message is received by the second network node that the second data has been received by the user equipment.

9. A method for use in a network node for buffer handling utilizing in-band control signaling, comprising:
obtaining a transmission status feedback message;
determining that a first buffer memory of a second network node contains first data, the first data having a first number associated therewith; and
sending a discard message to the second network node, the discard message comprising a second number associated with second data that is after the first number, the discard message indicating that the second network node is to discard all data up to the second number including the first data.

10. The method according to claim 9, wherein the first data is redundant to second data stored in a second buffer memory of a third network node.

11. The method according to claim 10, wherein the transmission status feedback message is obtained from the third network node and comprises an indication that the third network node delivered the second data to a user equipment.

12. The method according to claim 10, wherein the transmission status feedback message is obtained from the second network node and comprises an indication that a wireless connection between the second network node and a user equipment has deteriorated.

13. (canceled)

14. The method according to claim 10, further comprising sending a second discard message to the third network node, wherein the third network node is configured to ignore the discard message if the third network node has delivered the second data to a user equipment.

15.-16. (canceled)

17. The method according to claim 10, wherein the second network node and the third network node are alternating in sending data to a user equipment.

18. The method according to claim 10, wherein the discard message comprises a GPRS Tunneling Protocol User plane (GTP-U) packet data unit (PDU).

19. The method according to claim 18, wherein the GPRS Tunneling Protocol User plane packet data unit comprises an indication in a Next Extension Header of the GTP-U PDU.

20-22. (canceled)

23. A network node for buffer handling utilizing in-band control signaling, comprising:
at least one processing circuitry; and
at least one storage that stores processor-executable instructions that, when executed by the processing circuitry, causes the network node to:
store a plurality of data to be transmitted to a user equipment, each data of the plurality of data has an associated number, the plurality of data comprising first data to be transmitted to a user equipment, the first data having a first number associated therewith;
obtain a discard message from a second network node, the discard message comprising the first number indicating that all data of the plurality of data up to the first number is to be discarded; and
discard the first data and at least one additional data based on the discard message.

24. The network node according to claim 23, wherein the first data is redundant to second data stored at a third network node.

25. The network node according to claim 24, wherein the discard message comprises a GPRS Tunneling Protocol User plane (GTP-U) packet data unit (PDU).

26. The network node according to claim 25, wherein the GPRS Tunneling Protocol User plane packet data unit comprises an indication in a Next Extension Header of the GTP-U PDU.

27-29. (canceled)

30. The network node according to claim 23, wherein the discard message is obtained after an acknowledgement message is received by the second network node that the second data has been received by the user equipment.

31. A network node for buffer handling utilizing in-band control signaling, the network node comprising:
at least one processing circuitry; and
at least one storage that stores processor-executable instructions that, when executed by the processing circuitry, causes the network node to:
obtain a transmission status feedback message;
determine that a first buffer memory of a second network node contains first data, the first data having a first number associated therewith; and
send a discard message to the second network node, the discard message comprising a second number associated with second data that is after the first number, the discard message indicating that the second network node is to discard all data up to the second number including the first data.

32. The network node according to claim 31, wherein the first data is redundant to second data stored in a second buffer memory of a third network node.

33. The network node according to claim 32, wherein the transmission status feedback message is obtained from the third network node and comprises an indication that the third network node delivered the second data to a user equipment.

34. The network node according to claim 32, wherein the transmission status feedback message is obtained from the second network node and comprises an indication that a wireless connection between the second network node and a user equipment has deteriorated.

35. (canceled)

36. The network node according to claim 32, wherein the processor-executable instructions, when executed, cause the network node to send a second discard message to the third network node, wherein the third network node is configured to ignore the discard message if the third network node has delivered the second data to a user equipment.

37.-38. (canceled)

39. The network node according to claim 32, wherein the second network node and the third network node are alternating in sending data to a user equipment.

40. The network node according to claim 32, wherein the discard message comprises a GPRS Tunneling Protocol User plane (GTP-U) packet data unit (PDU).

41. The network node according to claim 40, wherein the GPRS Tunneling Protocol User plane packet data unit comprises an indication in a Next Extension Header of the GTP-U PDU.

42-46. (canceled)
